(19) United States
(12) Patent Application Publication
(10) Pub. No.: US 2008/0217437 A1
(43) Pub. Date: Sep. 11, 2008

(54) Optimized Method to Drive Electric Spray Guns

(75) Inventors: Jan Vanden Berghe, Oudenaarde (BE); Hans Saelens, Evergem (BE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Spraying Systems Co., Wheaton, IL (US)

(21) Appl. No.: 11/682,651

(22) Filed: Mar. 6, 2007

(51) Int. Cl. B05B 1/30; B05B 5/00

(52) U.S. Cl. 239/583; 239/585.1; 239/585.5; 251/129.21

(57) ABSTRACT

Methods and systems for efficiently driving, diagnosing and configuring an electric spray gun system use a pulse width modulated driving signal to achieve fast gun opening and closing times while minimizing the power consumption of the gun. Additionally, an example method and system for detecting the opening and closing of an electric spray gun is provided. Finally a method for determining parameters such as an electric spray gun's on current, off current and holding current is provided. Through use of the methods and systems provided herein, a technician can easily and effectively configure an electric spray gun for efficient use in a spraying system.

### BACKGROUND OF THE INVENTION

Spray guns and spray gun systems have a wide variety of applications in industrial settings today. Spray guns are very often used to disperse a liquid material, such as to cover an area or object with particles of the sprayed material. One primary area for use of such systems is in preparing of packaged or other food products. For example, a cereal product may be conveyed on a conveyor belt past an array of spray guns which coat the cereal product with sweetener, additives, supplements, etc. Such a system is often more practical than using a more targeted system such as manual or automated brushing, etc., to coat each unit of the food product.

Electric spray guns generate finely atomized sprays in many industrial and commercial applications. Electric spray guns apply a coating material such as liquid or powder paints to numerous products. Spray guns may be mounted on an industrial robot located on an assembly line. As an article of manufacture is located at the robot station, the robot precisely moves the gun. The gun program turns the spray on and off at appropriate times to coat the article.

One existing electric spray gun system employs a solenoid to control a plunger which allows the gun to be opened, such that an article will be sprayed, and closed, such that the gun stops spraying. In order to provide an electromagnetic field to control the plunger, the solenoid is energized. When the solenoid is de-energized, the plunger returns to the closed position.

Currently, the driving signal for such electric spray guns is a fixed, normal operating voltage. In the ‘off’ position, the solenoid drive will either be left floating (open-collector output type) or will be short-circuited (push-pull output type). Because of its inherent inductance, the solenoid coil act to temporarily maintain its holding current when the driving signal turns to zero. Therefore, the closing of the gun does not happen simultaneously with the change in the driving signal. This inductive delay between the driving signal and the operation of the gun results in imprecise control of the gun. This imprecise control may in turn lead to undesired variations in the thickness of the material being sprayed onto an article of manufacture. Additionally, the imprecise control of the gun may lead to unnecessary over spray whereby the article of manufacture is no longer in range of the spray gun while the gun is spraying.

Traditionally, the driving signal maintains a relatively constant voltage while the gun is in the open position. The driving signal then transitions to a zero value to close the gun and remains at the zero value for the duration of time the gun remains closed. During the period of time that the gun is in the open position, the driving signal voltage remains higher than needed to hold the gun open. This results in the consumption of excess power which is converted into heat, both in the gun and in the driver electronics.

To effect spray control, the frequency of the spray gun driving signal is typically fixed for each type of gun using a pulse width modulation (PWM) duty cycle control value. This results in a narrow PWM duty cycle control range. The length of time a gun is off cannot be easily increased or decreased and may lead to imperfections in the spraying process.

A technician often installs and configures spray gun systems. The installing technician must set a number of values including frequency, driving voltage, minimum duty cycle, maximum duty cycle, and the duration of the negative pulse. However, the technician often has little or no knowledge of spray gun systems. Therefore parameters are often set to safe values or left at default values. The sub-optimal configuration of spray gun systems results in numerous problems including product striping and the inefficient application of the sprayed material.

### BRIEF SUMMARY OF THE INVENTION

The invention provides an efficient method of controlling and configuring a spray gun system. Methods for driving an electric spray gun based on known parameters and/or parameters obtained thru diagnostics are provided. Additionally, a diagnostic procedure is provided for obtaining the values necessary to efficiently drive a spray gun system. In another aspect of the invention, in order to optimize the driving signal for a spray gun system, an apparatus and method for detecting the open and closed positions of a spray gun valve is provided.

Example methods for driving an electric spray gun to achieve rapid gun opening and closing times are provided. The methods for driving the spray gun can be implemented in control electronics such as an embedded processor. One preferred embodiment implements the method in software running on a microcontroller. One method utilizes known gun opening times, closing times and gun holding current to optimize the opening and closing signals. In this method, the nominal working voltage of the gun is applied until the gun's plunger is in the fully open state. The voltage is then removed and remains at approximately zero. The current through the solenoid is measured until the gun's holding current is reached. Once the current though the solenoid is equal to the holding current, a pulse width modulated power signal is supplied to the spray gun. The power signal modulates at a rate sufficient to approximately maintain the holding current until the end of the spray on cycle. At the end of the spray time interval, the system applies the nominal negative working voltage until the solenoid current equals approximately zero, completing the spraying cycle.

An alternative method of driving an electric spray gun uses the gun's on current, holding current and a zero-crossing detection circuit. In this method, a voltage higher than the nominal working voltage is applied to the solenoid until the current through the solenoid equals the gun's on current. Then the voltage is removed until the current through the solenoid equals the gun's holding current. Next a pulse width modulated power signal is supplied to the solenoid at a ratio sufficient to approximately maintain the holding current. At the end of the spray on cycle, a higher than nominal working negative voltage is applied. The system monitors the solenoid current until the solenoid current equals zero. When the current equals zero, the voltage is held at zero until the next spray on cycle.

Yet another method of driving an electric spray gun also uses the gun's on and holding currents. However the method uses an alternative process for detecting the end of the higher than nominal working negative voltage period. Rather than applying the higher than nominal working negative voltage until the solenoid current is equal to zero at the end of a spray on cycle as in the above example, the system applies the negative voltage until the current transitions from a negative value to a positive value. The measurement in this case is performed on the low, or negative side of the circuit powering the electric spray gun.

In another illustrated embodiment, a method of driving an electric spray gun is provided based on the gun's holding current and nozzle position, i.e., whether the gun nozzle is open or closed. The method applies a higher than nominal working voltage to the gun's solenoid until the gun is open. Detecting whether the gun is open can be accomplished using a pressure sensitive transmitter. A method and circuit for detecting whether the gun is opened is discussed in more detail hereinafter. After the gun opens, the voltage is removed and the current through the solenoid is monitored until the current equals the holding current of the gun. Next a pulse width modulated power signal is supplied to the solenoid at a ratio sufficient to approximately maintain the holding current. At the end of the spray on cycle, a higher than nominal working negative voltage is applied until the gun closes. After the gun closes, the voltage is held at zero until the next spray on cycle.

An exemplary diagnostics procedure is provided. The diagnostic procedure can be used to calculate parameters such as the gun's on current, off current and holding current. Based on these values, efficient methods, such as those discussed above, for controlling an electric spray gun can be developed.

The optimized method of driving an electric spray gun according to various embodiments of the invention incorporate other features and advantages that will be more fully appreciated from the following description in conjunction with the accompanying figures.

### BRIEF DESCRIPTION OF THE SEVERAL VIEWS OF THE DRAWINGS

FIG. 1 is a perspective view of an embodiment of the invention in which an electric solenoid-operated spray gun is mounted on a robotic arm;

FIG. 2 is a perspective view of a solenoid-operated spray gun constructed in keeping with an embodiment of the invention;

FIG. 3 is a longitudinal section of the spray gun of FIG. 2 taken along the plane of the line 3-3;

FIG. 4 is a schematic illustration of an embodiment of the invention showing components and logical connections in a control and power system for a spray gun;

FIG. 5A is a timing diagram illustrating a power signal from the gun driver of FIG. 4 to the electric spray gun of FIG. 4;

FIG. 5B is a timing diagram illustrating a current through the solenoid of the electric spray gun of FIG. 3 in accordance with the example power signal of FIG. 5A;

FIG. 5C is a timing diagram illustrating a plunger position of the electric spray gun as illustrated in FIG. 3;

FIG. 5D is a timing diagram illustrating current measured on the low side of the electric gun driver as illustrated in FIG. 4;

FIG. 6 is a flow chart illustrating a method of controlling an electric spray gun based on the opening and closing times of the gun and the gun holding current in keeping with an embodiment of the invention;

FIG. 7 is a flow chart illustrating a method of controlling an electric spray gun using the on current and the holding current for the spray gun;

FIG. 8 is a flow chart illustrating a method of controlling an electric spray gun using the on current and the holding current for the spray gun and shows a calibration technique for a spray gun control system;

FIG. 9 is a flow chart illustrating a method of controlling an electric spray gun using gun on/off detection and the holding current;

FIG. 10 is a flow chart illustrating a method of performing diagnostics on an electric spray gun to determine the on current, the off current and the holding current;

FIG. 11 is a schematic illustration of an example circuit for detecting the ON/OFF position of an electric spray gun;

FIG. 12 is a flow chart illustrating a method of calibrating the example circuit provided in FIG. 11 and performing electric spray gun diagnostics as in FIG. 10.

### DETAILED DESCRIPTION OF THE INVENTION

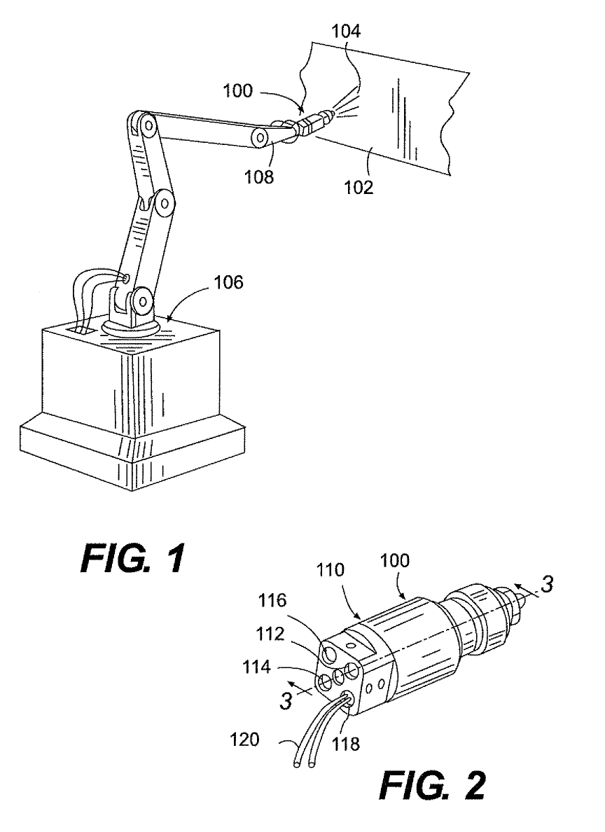

The present invention generally relates to methods and systems for implementing the logical operations of an electronic spray gun controller. For implementing the improved spraying technique described herein, the invention includes in one configuration a robotic spray gun system, as shown in FIG. 1. This spray gun system provides a spray gun mounted on a moveable arm for spraying objects of manufacture. It should be noted that the invention is intended to work with any solenoid-operated spray gun system and is not limited to the robotic system illustrated in FIG. 1. In this example, a solenoid-operated spray gun 100 sprays an object of manufacture 102 with a finely atomized spray 104. The robot 106 supports the spray gun 100 on an articulated arm 108. The arm 108 can be configured to support a single spray gun 100 or multiple spray guns. The article of manufacture 102 can include numerous products, such as food items, consumer goods or industrial goods. The arm 108 of the spray gun 100 may be selectively moved by the robot 106 such that the finely atomized spray 104 from the gun covers selected areas of an article of manufacture 102.

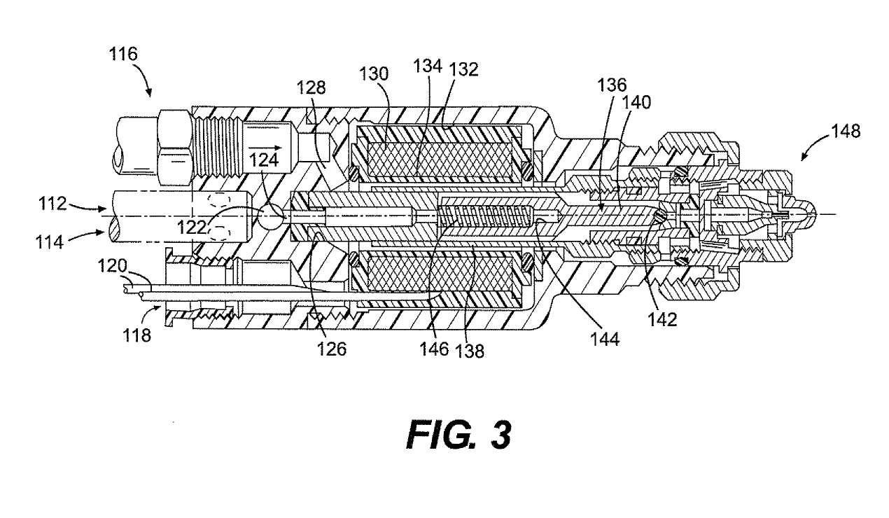

For providing the improved control allowed by the invention, the spray gun head may be as illustrated in FIG. 2. This Figure provides a detailed illustration of the outer casing and connections of one spray gun 100 that may be used in the system. The spray gun 100 is formed from a housing body 110 with a pair of liquid ports 122, 114. The port 112 feeds liquid to the gun and port 114 connects to a return line. Port 116 provides pressurized air to the spray gun 100. Finally, port 118 provides a connection to the spray gun 100 for control signal cables 120. The illustrated spray gun provides only one example of spray guns that will work in the system. Further, the connections and ports on the illustrated spray gun need not be present on all spray guns.

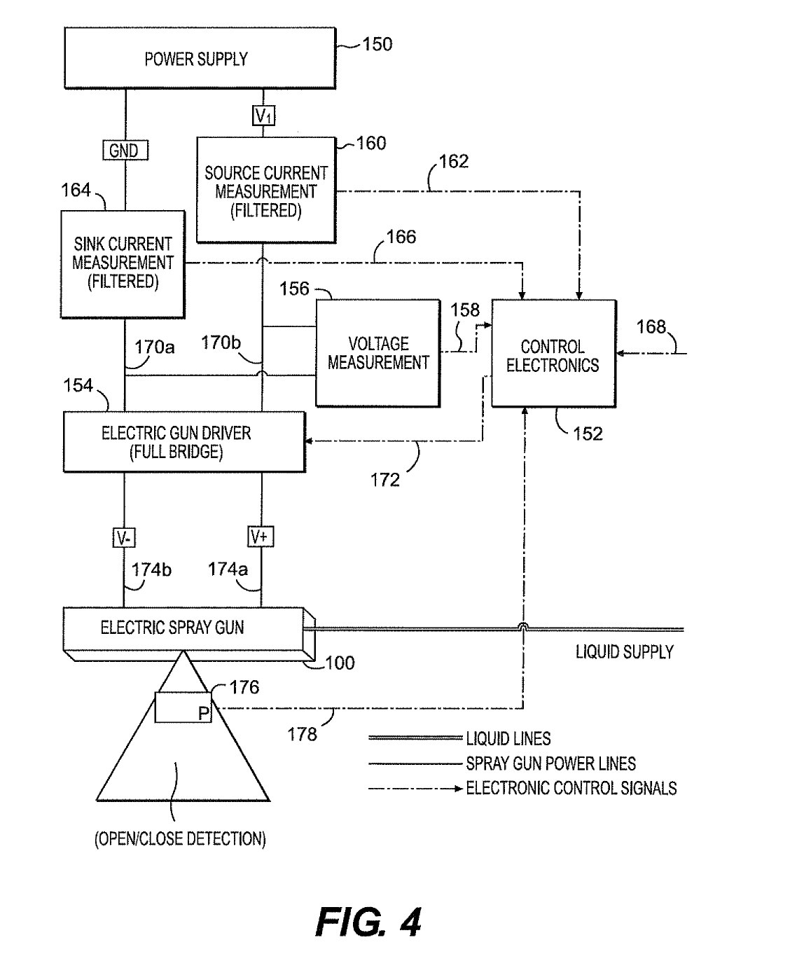

FIG. 3 provides a longitudinal cross sectional view of the example spray gun in FIG. 2 taken along the plane of the line 3-3. The liquid feed port 112 and liquid return port 114 are interconnected by a cross bore 122, which connects with a central liquid flow passage 124 that extends into a counterbore 126. The air inlet port 116 connects to a feed passage 128 which passes air into the counterbore 126. The solenoid coil 130 is housed within a longitudinal chamber 132. The solenoid coil 130 includes a conventional wound coil about a plastic spool 134. The coil 130 connects to the control signals 120 through the control signal port 118.

To prevent or allow the passage of sprayed liquid, a reciprocal valve plunger 136 made of a metal or other material is disposed within a tube 138 immediately down-stream of the solenoid coil 130. The plunger 136 has a needle portion 140 which, when in the closed position, seats in a valve 142 closing the central liquid passage 144. A spring 146 biases the plunger 136 in a closed position such that the needle 140 seats in the valve 142. When the solenoid 130 is energized, the plunger 136 is moved to an open position against the biasing force of the spring 146 and liquid is directed through the liquid passage 144, through the valve 142 and out the nozzle assembly 148. In order to move the plunger 136 and needle 140 between open and closed positions it is necessary that a flux loop be generated which encompasses and magnetically acts upon the plunger 136. The solenoid 130 induces the flux loop which then acts upon the plunger 136. The flux loop can be created through the use of a magnetically conductive outer structure for the spray gun 100 or by utilizing a metallic, radial flux-deflecting element adjacent to at least one end of the solenoid coil 130.

By selectively energizing the solenoid coil 130, the flux loop moves the plunger 136 rearward against the force of the biasing spring 146 to open the valve 142 and permit the flow of pressurized liquid. The de-energizing of the solenoid coil 130 permits the plunger 136 to be returned to its closed position under the force of the biasing spring 146. One example of a spray gun which can be used with this system is described in U.S. Pat. No. 7,086,613, the disclosure of which is fully incorporated by reference to the same extent as if the disclosure was set forth in its entirety herein. However, other spray guns will work in this system and the above described spray gun is merely provided as an example.

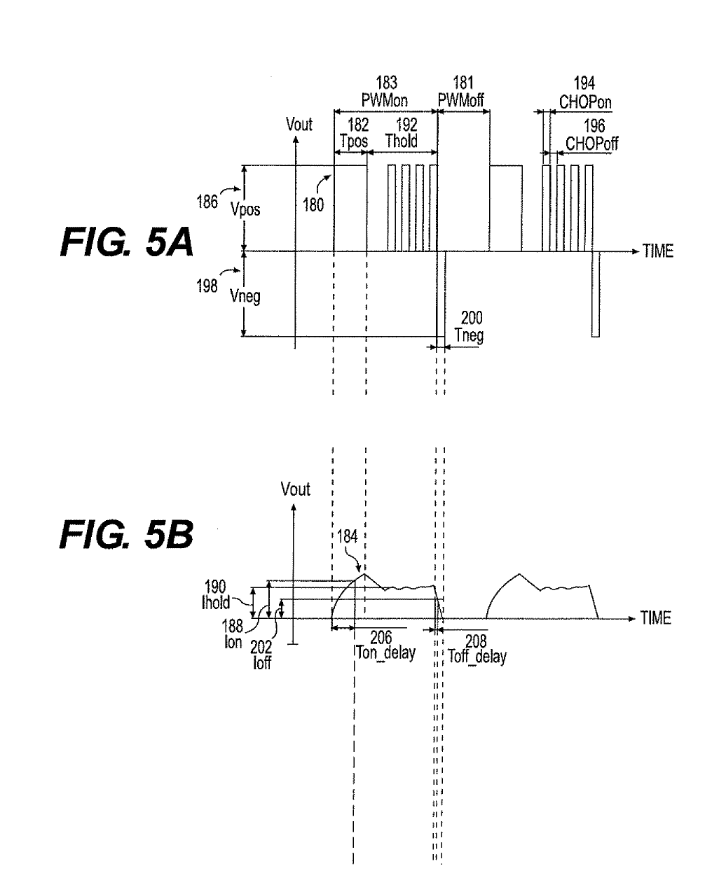

In order to operate properly in accordance with invention, a spray gun must be provided with a solenoid drive signal and an appropriate liquid supply source. FIG. 4 illustrates logical power, control and liquid lines used in one embodiment of the invention. In this embodiment, power supply 150 provides electrical power to the control electronics 152 and the gun driver 154. In one preferred embodiment, the power supply 150, control electronics 152 and gun driver 154 are placed on a single printed circuit board (PCB). The PCB can then be placed within a housing. However, in alternative embodiments, the power supply 150, control electronics 152 and gun driver 154 can be placed in separate housings or integrated into the spray gun 100 housing.

In order to measure the applied voltages, the control electronics 152 either constantly or intermittently measure the voltage supplied to the gun driver 154. The voltage is measured by a voltage measuring circuit 156. The voltage measuring circuit 156 provides a signal 158 to the control electronics 152 indicating the input voltage to the gun driver 154. In addition to monitoring the voltage, the control electronics 152 monitor the source current and sinking current between the power supply 150 and the gun driver 154. The source current is measured by a current measurement circuit 160 and the value of the source current being supplied to the gun driver 154 is monitored by the control electronics 152 through the use of signal line 162. Similarly, a current measurement circuit 164 measures the gun driver sinking current and provides a signal to the control electronics 152 by way of connection 166.

The control electronics 152 can be implemented in a number of ways including by use of a dedicated circuit, an embedded microprocessor or by general purpose computer. In one preferred embodiment, the control electronics are implemented in an embedded microcontroller on the same PCB as the gun driver 154 and the power supply 150. One example of an appropriate microcontroller is the PIC® microcontroller manufactured by Microchip Technology Inc. The control electronics 152 may except system control signals 168. The system control signals 168 can include numerous pieces of information such as whether the gun should be turned on or off. Finally, the control electronics can monitor the spray gun 100 using an open/close detection circuit to determine whether the gun is currently opened or closed. If the open/close detection circuit is used, the open closed detection circuit 176 provides a control signal 178 to the control electronics 152. In one embodiment, the open/close detection circuit 176 uses a pressure sensitive transmitter bridge in front of the spray gun 100 nozzle 148. As the air pressure changes when the gun 100 is opened, the pressure sensitive transmitter bridge indicates a change in pressure and the open/close detection circuit 176 sends the appropriate control signal to the control electronics 152. However, in other embodiments, the detection circuit can be built into the spray gun head or the circuit can be integrated into the gun as a position detection circuit for the plunger. Any appropriate method for detecting the open/close position of the gun may be used.

In order to effectively supply power to the gun solenoid, the gun driver 154 is preferably a full bridge power driver. The gun driver 154 receives power from the power supply 150 via power lines 170a and 170b. The gun driver 154 also receives control signals 172 from the control electronics 152. The gun driver 154 provides power signals 174a and 174b to the spray gun 100. The power signals 174 may directly energize the solenoid coil 130 (FIG. 3) in order to move the plunger 136 such that the valve 142 opens and liquid can be discharged. An example full bridge driver is built around the Intersil HIP4082. The full bridge driver may output a pulse width modulated power signal 174 in order to energize the solenoid 130. However, the power signal 174 may also be held positive, negative or at zero. The control and power signals will be more fully discussed hereinafter.

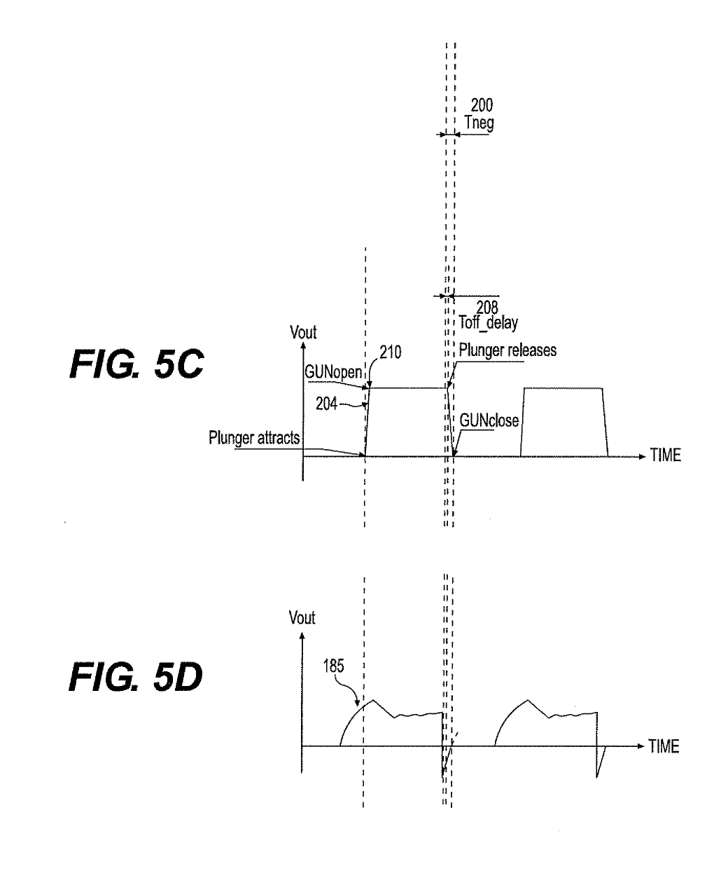

FIG. 5A illustrates one embodiment of the power signal between the full bridge electric gun driver 154 and the electric spray gun 100. In one embodiment, the power signal is generated by the full bridge gun driver 154 based on control signals 172 from the control electronics 152. In this example, the electric spray gun 100 is closed during periods when the power signal voltage 180 is held at zero, for example during interval PWM_{off} 181. The gun 100 is open during periods when the power signal is held at a positive voltage or modulated such that the current through the solenoid 130 remains high enough to hold the gun plunger 136 open, such as during interval PWMₒₙ 183. The relationship of interval PWMₒₙ 183 to interval PWM_{off} 181 represents a low frequency pulse-width modulated signal for controlling the spray-on time of the gun. A more detailed description of the opening and closing of the spray gun in relation to the power signal is discussed hereinafter.

FIG. 5B illustrates the current 184 through the solenoid 130 in the electric spray gun 100. During interval Tₚₒₛ, 182 the control electronics 152 hold the power signal 180 at a positive voltage Vₚₒₛ 186. During interval Tₚₒₛ 182, the current 184 through the solenoid 130 ramps from approximately zero to a value greater than Ion 188. Ion 188 represents the current through the solenoid 130 sufficient to begin moving the plunger 136 of the electric spray gun. At the end of interval Tₚₒₛ 182, the voltage 180 is held at approximately zero until the current 184 through the solenoid 130 is approximately equal to I_{hold} 190. I_{hold} 190 represents the current through the solenoid 130 sufficient to attract the plunger 136 such that the gun remains open. The plunger 136 is attracted such that the gun is held open during time period T_{hold} 192. In order to maintain I_{hold} 190 throughout the time T_{hold} 192, the power signal 180 is modulated at a rate of CHOPₒₙ 194 over CHOP_{off} 196. The ratio of CHOPₒₙ 194 to CHOP_{off} 196 represents a high frequency modulated signal for maintaining I_{hold} 190. In this embodiment CHOPₒₙ 194 equals approximately Vₚₒₛ 186 and CHOP_{off} 196 equals approximately zero. However any appropriate values can be used for CHOPₒₙ 194 and CHOP_{off} 196 such that the current through the solenoid 130 equals approximately I_{hold} 190 or greater.

To assure prompt closure of the valve, the power signal 180 from the full bridge driver 154 is held at approximately zero during interval PWM_{off} 181. By driving the power signal 180 to a negative voltage V_{neg} 198 for a short period of time T_{neg} 200, the current 184 through the solenoid 130 reaches I_{off} 202 more quickly than if the power signal voltage 186 was held at approximately zero. I_{off} 202 represents the current through the solenoid 130 at which the solenoid 130 releases the plunger 136 causing the gun 100 to close. At the end of the T_{neg} 200 time interval, the current 184 through the solenoid 130 is approximately zero. In this example, at the end of the T_{neg} 200 time period, the gun driver 154 holds the power signal voltage 180 at approximately zero for the remainder of the PWM_{off} 181 time period.

FIG. 5C illustrates the plunger position 204 of the electric spray gun 100. The position of the plunger is determined by the current 184 through the solenoid 130. In one embodiment, the plunger 136 is closed when the current 184 through the solenoid 130 is less than Ion 188. The plunger 136 moves towards the open position after the current 184 through the solenoid 130 reaches Ion 188. In order to maintain the plunger 136 in the open position, the current through the solenoid must remain greater than or equal to I_{hold} 190. Tₒₙ_{_{—}}_{delay} 206 represents the time from the start of PWMₒₙ 183 and a positive power signal voltage 180 until the current through the solenoid is sufficient to attract the plunger 136 at Ion 188. The plunger is in the fully open position 210 after some additional time while the current 184 through the solenoid 130 increases. Similarly, T_{off}_{_{—}}_{delay} 208 represents the time from the beginning of PWM_{off} 181 until the plunger 136 begins to close. The plunger 136 is fully closed when the current 180 through the solenoid 130 equals approximately zero. In order to spray as accurately as possible, it is desirable to minimize Tₒₙ_{_{—}}_{delay} 206 and T_{off}_{_{—}}_{delay} 208.

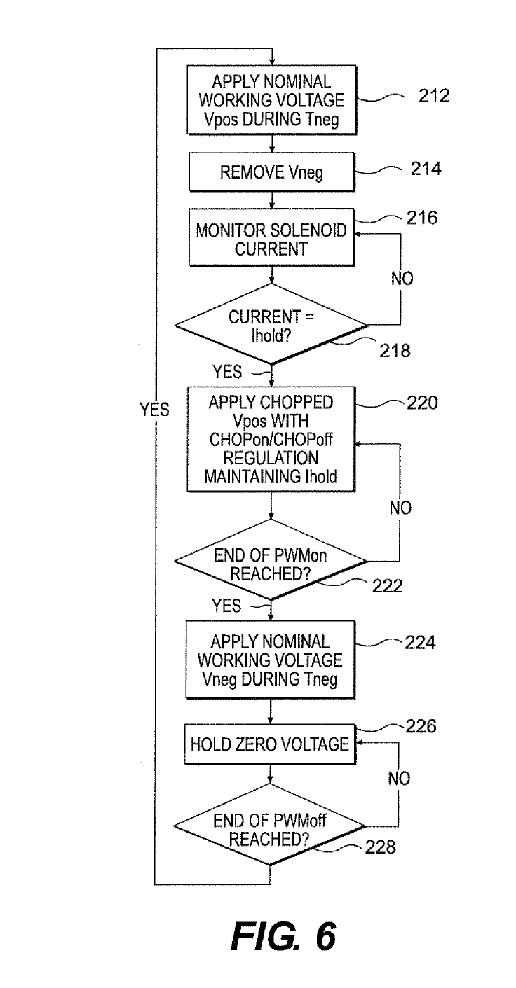

The flow chart of FIG. 6 illustrates one method of driving an electric spray gun 100 to achieve improved gun valve opening and closing response times. Methods for driving the spray gun 100 can be implemented in control electronics 152. One preferred embodiment implements the method in software running on a microcontroller. The method illustrated in FIG. 6 uses known gun valve opening times, Tₚₒₛ 182, and closing times, T_{neg} 200. Additionally, the holding current, I_{hold} 190 is known. Stage 212 on FIG. 6 corresponds to the beginning of a spraying cycle at the beginning of PWMₒₙ 183.

At stage 212, the nominal working voltage Vₚₒₛ 186 is applied during time period Tₚₒₛ 182 until the plunger 136 is in the fully open state at position 210. The nominal working voltage is the voltage sufficient to hold the plunger 136 of the spray gun open and maintain I_{hold} 190 (FIG. 5B). The voltage is removed at stage 214 and remains at approximately zero. During stage 216 the current 184 through the solenoid 130 is measured. At decision stage 218 the system detects whether the current 184 through the solenoid 130 equals I_{hold} 190, the current 184 at least sufficient to hold the plunger 136 open. As long as the current 184 is greater than I_{hold}, the system continues to monitor the solenoid current at stage 216. Once the current 184 equals I_{hold} 190, a pulse width modulated power signal 180 is supplied to the solenoid 130 at stage 220. The power signal 180 modulates at a rate of CHOPₒₙ 194 to CHOP_{off} 196 where the ratio is sufficient to maintain I_{hold} 190. At decision stage 222 the system determines whether the end of PWMₒₙ 183 has been reached. If the end of PWMₒₙ 183 is reached, the system applies the nominal working voltage V_{neg} 198 for a time period equal to T_{neg} 200. After T_{neg} 200, the solenoid current 184 equals approximately zero. Stage 226 holds the current at zero. At decision stage 228 the system determines if the end of PWM_{off} 181 has been reached. When the end of PWM_{off} 181 is reached, the next cycle begins and the method returns to stage 212.

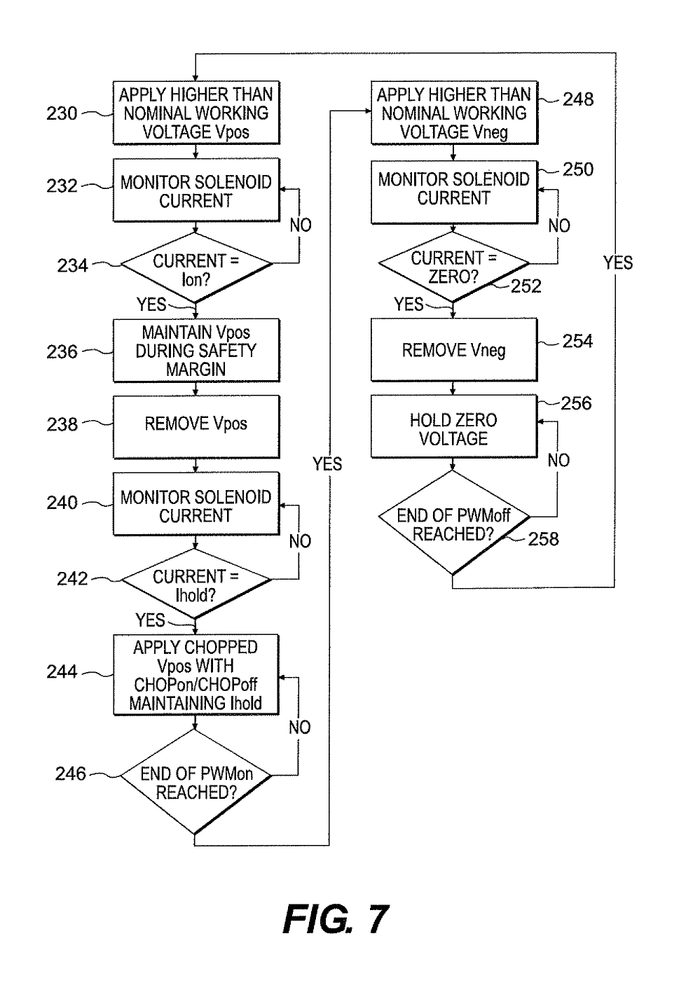

The flow chart of FIG. 7 illustrates an alternative method of driving an electric spray gun 100 to achieve fast gun opening and closing times. The method illustrated in FIG. 7 uses the spray gun's 100 on current, Ion 188 and holding current, I_{hold} 190. Stage 230 corresponds to the beginning of a spraying cycle at the beginning of PWMₒₙ 183. A voltage higher than the nominal working voltage of Vₚₒₛ 186 is applied to the solenoid 130. The current 184 through the solenoid 130 is monitored at stage 232. At decision stage 234 the system determines if the current 184 equals Ion 188, the current necessary to begin attracting the plunger 136. If the current 184 does not equal Ion 188, the solenoid current continues to be monitored (stage 232), otherwise Vₚₒₛ 236 is maintained for a safety interval at stage 236. The safety interval ensures that the gun is fully opened. The interval can be eliminated in some embodiments of the invention. The safety interval is determined based on the specific gun, spraying control system and applied liquid or air pressure. After the safety interval, Vₚₒₛ 186 is removed at stage 238. Next, the solenoid 130 current 184 is monitored (stage 240).

At decision stage 242 the system determines if the current 184 equals I_{hold} 190, the current necessary to hold the plunger 136 in the open state. If the current 184 is greater than I_{hold} 190, the system continues to monitor the current 184 (stage 240). If the current 184 equals I_{hold} 190, a pulse width modulated power signal 180 is supplied to the solenoid 130 at stage 244. The power signal 180 modulates at a rate of CHOPₒₙ 194 to CHOP_{off} 196 where the ratio is sufficient to maintain I_{hold} 190. The ratio of CHOPₒₙ 194 to CHOP_{off} 196 results in a high frequency modulated power signal 180. At decision stage 246 the system determines if the end of the spray on cycle, PWMₒₙ 183 has been reached. If the end of PWMₒₙ 183 has not been reached, the system continues to apply a chopped power signal 180. When the end of PWMₒₙ 183 is reached, a higher than nominal working voltage, V_{neg} 198 is applied at stage 248.

The system monitors the solenoid current 184 (stage 250). At decision stage 252, the system determines if the solenoid current 184 equals zero. If the current 184 does not equal zero, the system continues to monitor the current 184 (stage 250). When the current 184 equals zero, V_{neg} 198 is removed (stage 254) and the voltage 180 is held at zero (stage 256). At decision stage 258, the system determines if the end of the PWM_{off} 181 time period has been reached. If the end of PWM_{off} 181 has not been reached, the system continues to hold the voltage 180 at zero. If the end of PWM_{off} has been reached, the system begins the next spraying cycle by returning to stage 230.

The method illustrated in FIG. 7 applies a higher than nominal working voltage Vₚₒₛ 186 at stage 230 and a higher than nominal voltage V_{neg} 198 at stage 248. The higher than nominal Vₚₒₛ 186 voltage allows the current 184 through the solenoid 130 to increase at a higher rate. Thus, the plunger 136 moves at a faster rate, causing the gun to open more quickly. Conversely, the higher than nominal V_{neg} 198 voltage allows the current 184 through the solenoid 130 to decrease at a higher rate. Thus, the plunger 136 moves at a faster rate, causing the gun to close more quickly. By monitoring the current 184 through the solenoid 130 at stages 232 and 250, the system can determine the proper time to remove the higher than nominal voltages. In the method illustrated in FIG. 7, the solenoid current 184 is measured directly in series with the solenoid 130. Although the method of FIG. 7 preferably utilizes higher than nominal voltages, nominal Vₚₒₛ 186 and V_{neg} 198 voltages may also be used.

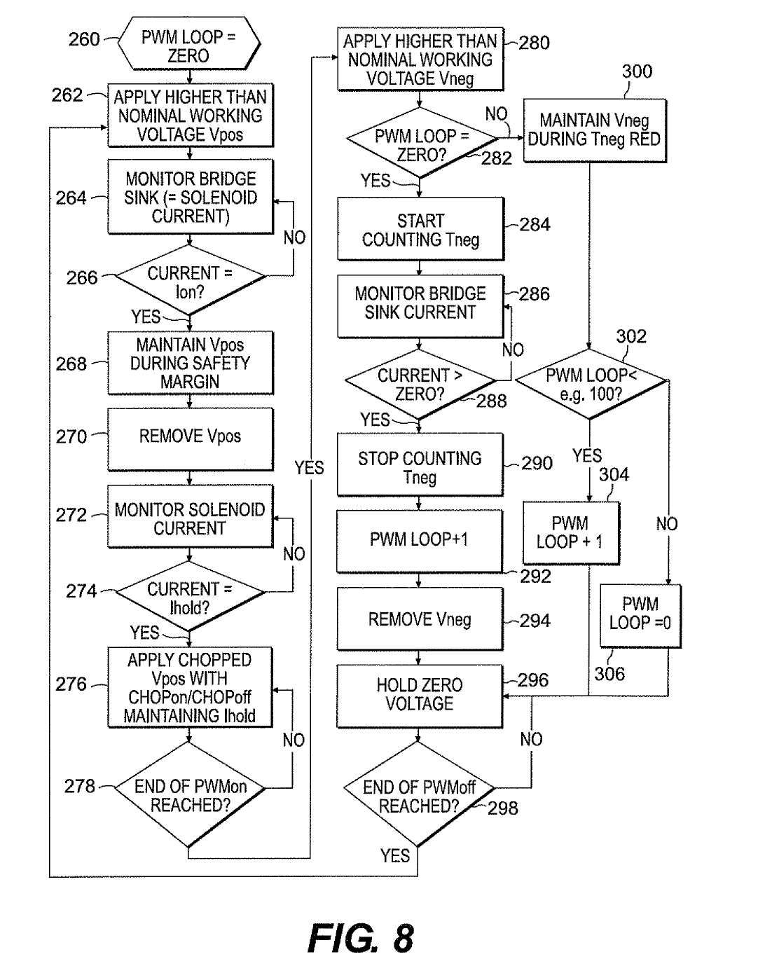

The flow chart of FIG. 8 illustrates an embodiment of the invention for driving an electric spray gun 100 to achieve faster opening and closing times. The method illustrated in FIG. 8 uses the spray gun 100 on current, Ion 188 and holding current, I_{hold} 190. Additionally, the method allows the solenoid current 184 to be approximated via the low side 170a (FIG. 4) of the bridge driver 154. The current 185 measured at the low side 170a of the bridge driver is depicted in FIG. 5D. Alternatively, in another embodiment, the solenoid current is measured by monitoring the source current 170b on the high side of the bridge driver, which substantially equals the solenoid current. When referenced to the ground, the current 185 as depicted in FIG. 5D is represented. The illustrated method shows an optional calibration to be executed after a given interval, such as after every 100 cycles of the spraying system. The frequency of the calibration process can be changed as needed. Additionally, the calibration process can be eliminated from the method if the calibration is not needed, for example if the spraying system maintains uniform parameters. The calibration process is discussed in further detail below.

The illustrated example of FIG. 8 determines if the spray system has cycled 100 times. In this example, a counter “PWM loop” is used to track the number of cycles. The counter is set to zero (stage 260) upon initializing the illustrated method. After setting the counter to zero, at stage 262 a voltage higher than the nominal working voltage of Vₚₒₛ 186 is applied to the solenoid 130. The current 184 through the solenoid 130 is monitored at stage 264. The current 184 is monitored at the bridge driver 154 sink 170a (FIG. 4). The sink current measurement 164 equals the solenoid current 184. At decision stage 266, the system determines if the current 184 equals Ion 188, the current necessary to begin attracting the plunger 136. If the current 184 does not equal Ion 188, the system continues to monitor the current 184 (stage 264). When the current 184 equals Ion 188, at stage 268 the system optionally maintains Vₚₒₛ 186 for a safety interval. The safety interval ensures that the gun is fully opened.

The safety interval is determined based on the specific gun, spraying control system and applied liquid or air pressure. After the safety interval, Vₚₒₛ 186 is removed at stage 270. Next, at stage 272 the solenoid 130 current 184 is monitored thru the sink current measurement device 164. At decision stage 274 the system determines if the current 184 equals I_{hold} 190, the current necessary to hold the plunger 136 in the open state. If the current 184 is greater than I_{hold} 190, the system continues to monitor the current 184 (stage 240). If the current 184 equals I_{hold} 190, a pulse width modulated power signal 180 is supplied to the solenoid 130 at stage 276. The power signal 180 modulates at a rate of CHOPₒₙ 194 to CHOP_{off} 196 where the ratio is sufficient to maintain I_{hold} 190. At decision stage 278 the system determines if the end of the spray on cycle, PWMₒₙ 183 has been reached. If the end of PWMₒₙ 183 has not been reached, the system continues to apply a chopped power signal 180. When the end of PWMₒₙ 183 is reached, a higher than nominal working voltage, V_{neg} 198 is applied at stage 280.

While applying V_{neg} 198, the system checks the counter “PWM loop” at stage 282 to determine if the counter equals zero. If the counter equals zero, the system is in a calibration loop. At stage 284, the system begins counting the time (T_{neg}) that V_{neg} 198 is applied. At decision stage 288, the system monitors the current 185 at the low side 170a of the full bridge driver. The current 185 reverse polarity at the time PWMₒₙ 183 goes to zero as a result of the back electromagnetic force (EMF). The current 185 returns to zero as the solenoid discharges. When the current 185 transitions from a negative value to a positive value, the system stops counting the time at stage 290 and increments the counter at stage 292. V_{neg} 198 is removed (stage 294) and the voltage 180 is held at zero (stage 296). At decision stage 298, the system determines if the end of the PWM_{off} 181 time period has been reached. If the end of PWM_{off} 181 has not been reached, the system continues to hold the voltage 180 at zero (stage 296). If the end of PWM_{off} has been reached, the system begins the next spraying cycle by returning to stage 262.

Returning to stage 282, if the counter does not equal zero, the system is not in a calibration loop. At stage 300, V_{neg} 198 is applied for a predetermined time T_{neg}_{_{—}}_{red} where T_{neg}_{_{—}}_{red} is less than T_{neg}. Therefore, T_{neg}_{_{—}}_{red} compensates for a spike in the low side bridge 174a current 185 after the solenoid current 184 discharges. In this example T_{neg}_{_{—}}_{red} is calculated during the calibration process and equates to T_{neg}. However, the length of time to maintain V_{neg} 198 can also be predetermined, in which case the calibration loop is not needed. Additionally, the calibration loop can be run only at system startup or at any interval selected manually or automatically. After applying V_{neg} 198, at decision stage 302 the system determines if the counter “PWM loop” is less than a predetermined calibration interval. In this example, the calibration interval is set to 100. If the counter is less than the calibration interval, the counter is incremented (stage 304). If the counter is not less than the calibration interval, the counter is set to zero.

In this example, the next time the system reaches at decision stage 282 a calibration will be performed based on the counter equaling zero. After setting the counter in stage 304 or stage 306, the system holds the zero voltage at stage 296 as in the above described calibration loop. At decision stage 298, the system determines if the end of the PWM_{off} 181 time period has been reached. If the end of PWM_{off} 181 has not been reached, the system continues to hold the voltage 180 at zero (stage 296). If the end of PWM_{off} has been reached, the system begins the next spraying cycle by returning to stage 262.

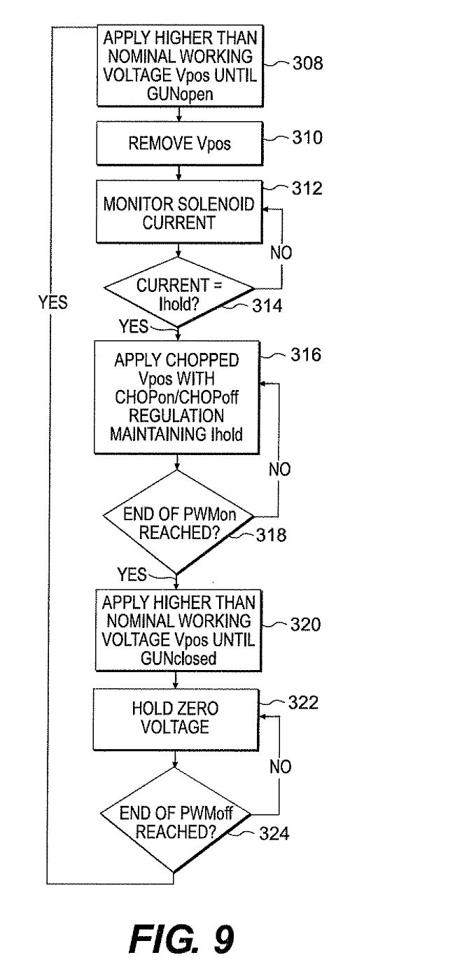

The flow chart of FIG. 9 illustrates one method of controlling an electric spray gun using gun on/off detection and the gun's holding current in keeping with one embodiment of the invention. The method begins at stage 308 by applying a higher than nominal working voltage Vₚₒₛ 186 to the solenoid 130 until the gun is open. Detecting whether the gun is open can be accomplished using a number of methods and devices including a pressure sensitive transmitter. A method and circuit for detecting whether the gun is open using a pressure sensitive transmitter is discussed in more detail hereinafter.

After the gun opens, Vₚₒₛ 186 is removed at stage 310. At stage 312 the current 184 through the solenoid is monitored. At decision stage 314 the system determines if the current 184 equals the holding current, I_{hold} 190 of the gun. If the current 184 does not equal I_{hold} 190, stage 312 continues to monitor the current. If I_{hold} 190 does equal the current 184, a chopped Vₚₒₛ 186 is applied such that the signal modulates at a rate of CHOPₒₙ 194 to CHOP_{off} 196 where the ratio is sufficient to maintain I_{hold} 190. At decision stage 318 the system determines if the end of the spray on cycle, PWMₒₙ 183 has been reached. If the end of PWMₒₙ 183 has not been reached, the system continues to apply a chopped power signal 180. When the end of PWMₒₙ 183 is reached, a higher than nominal working voltage, V_{neg} 198 is applied at stage 320 until the gun closes. At decision stage 322, the system determines if the end of the PWM_{off} 181 time period has been reached. If the end of PWM_{off} 181 has not been reached, the system continues to hold the voltage 180 at zero (stage 322). If the end of PWM_{off} has been reached, the system begins the next spraying cycle by returning to stage 262.

Although the foregoing examples embody suitable methods within the invention for controlling an electric spray gun,it will be appreciated that these examples are provided for illustrative purposes. As such, other methods for controlling an electric spray gun within the invention are also contemplated. Further, it is contemplated that various aspects of the above exemplary methods will be combined as a particular application requires.

In order to efficiently control an electric spray gun, a number of parameters may be needed. Examples of parameters used to control a spray gun are Ion 188, I_{off} 202 and I_{hold} 190. Ion 188 represents the current through the solenoid 130 sufficient to attract the plunger 136 of the electric spray gun such that the gun begins to open. I_{off} 202 represents the current through the solenoid 130 at which the plunger 136 in the gun 100 releases and the gun begins closing. I_{hold} 190 represents the current through the solenoid 130 sufficient to hold the plunger 136 such that the gun remains in the open position. However, a particular method of controlling a spray gun may use all of the parameters, none of the parameters or some combination of the parameters.

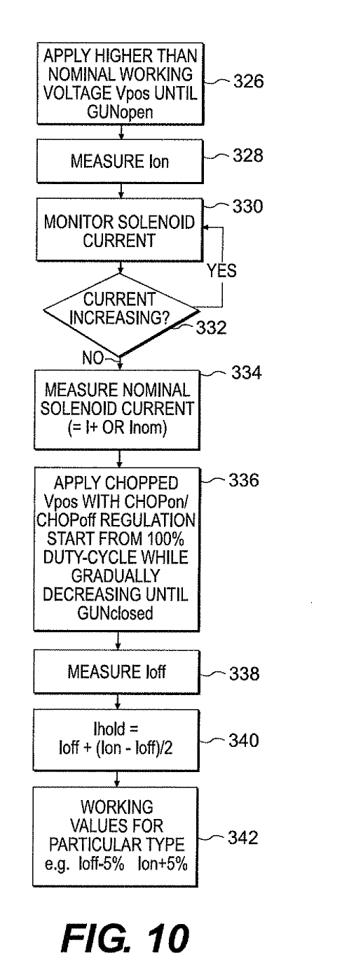

FIG. 10 provides a diagnostic procedure for determining Ion 188, I_{off} 202 and I_{hold} 190. The diagnostic procedure can be run as needed to determine parameters for a particular spray gun 100. The diagnostic procedure may not be needed if the spray gun manufacturer provides the values for a particular system. The procedure begins at stage 326 by applying the nominal working voltage Vₚₒₛ 186 to the solenoid 130 until the gun opens. Once the gun opens, the current 184 through the solenoid 130 is measured at stage 328 to determine Ion 188. The voltage is not removed from the solenoid 130. At stage 330, the solenoid current 184 is monitored. At decision stage 332 the system determines if the current 184 is increasing. If the current continues to increase, stage 330 continues to monitor the solenoid current 184. When the current stops increasing, the nominal solenoid current is measured at stage 334.

At stage 336 a chopped Vₚₒₛ 186 is applied such that the signal modulates at a rate of CHOPₒₙ 194 to CHOP_{off} 196. The duty cycle of the chopped signal is gradually reduced until the gun closes. When the gun closes, the current 184 through the solenoid 130 is measured to determine I_{off} 202. I_{off} 202 represents the current through the solenoid 130 at which the plunger 136 in the gun 100 releases, causing the gun to close. After determining I_{off} 202, I_{hold} 190 can be calculated according to the relationship I_{hold}=I_{off}+(Ion−I_{off})/2. However, additional I_{hold} 190 values can be obtained by adding an interval to I_{off} 202 and determining whether the gun remains open. For example, adding 10% to the value of I_{off} 202 may be sufficient to hold the gun open. If adding 10% to the value of I_{off} 202 does not keep the gun open, the system can repetitively increase the interval added to I_{off} 202, for example 20%, and determine whether the gun remains open.

After determining I_{hold} 190, at stage 342 working values are calculated. For example, a particular system may require a safety interval of five percent. In this case the working value for I_{off} would be the calculated I_{off}−5%. The working value for Ion would be the calculated Ion+5%. Depending on the application and the spraying system, the safety interval can be adjusted from 0, no interval, to any suitable interval. As shown in FIG. 10, working values are calculated at stage 342, however working values can be calculated at any time during the exemplary procedure. For example, the working value of I_{off} 202 can also be calculated in stage 338 at the time I_{off} 202 is measured.

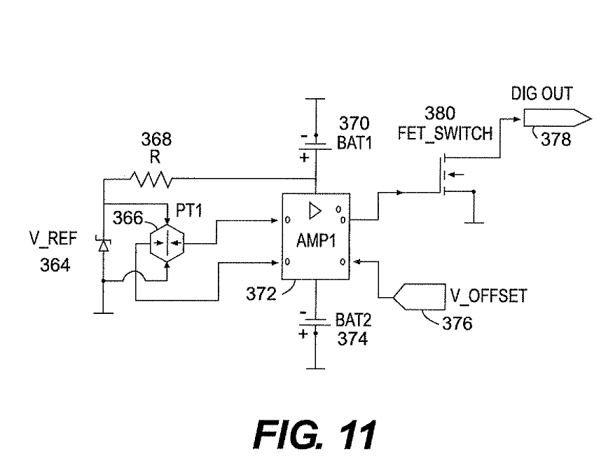

For detecting the ON/OFF position of an electric spray gun in keeping with an embodiment of the invention, a circuit such as illustrated in the schematic illustration of FIG. 11 is provided. By providing an ON/OFF detection circuit, the method illustrated in FIG. 10 can efficiently calculate Ion, I_{off} and I_{hold}. However, the ON/Off detection circuit and diagnostics procedure are not necessary in all embodiments of the invention. For example, a gun manufacturer may provide these values to end users. The values may be determined through other means. The circuit illustrated in FIG. 11 contains a voltage supply V_REF 364 and resistor 368 which provide a stable supply voltage to a pressure transmitter bridge 366. The pressure transmitter bridge is placed in front of the gun 100 nozzle assembly 148 with a small air gap between the bridge 366 and the nozzle 148. A high gain instrumentation amplifier 372 may be used in saturation. A battery 370 provides the on voltage to the amplifier 372. A second battery 374 provides the off voltage to the amplifier 372. It should be noted that although the example uses batteries 370, 374, any suitable power supply may be used. A variable offset voltage 376 biases the amplifier 372. The offset voltage is set such that the amplifier 372 output clamps to battery 374 at barometric pressure. Air pressure caused by the gun 100 in the on position causes the amplifier 372 to clamp to the positive battery 370 substantially at the moment the gun 100 opens. A field effect transistor (FET) 380 connects to the amplifier 372 and provides a digital output 378 from the circuit. In this example, the FET 380 is open at barometric pressure, which is when the gun 100 is in the closed position. When the gun 100 opens, the FET switches to ground. Thus, by monitoring the digital output 378, it can be determined whether the gun 100 is in the open (on) or closed (off) position.

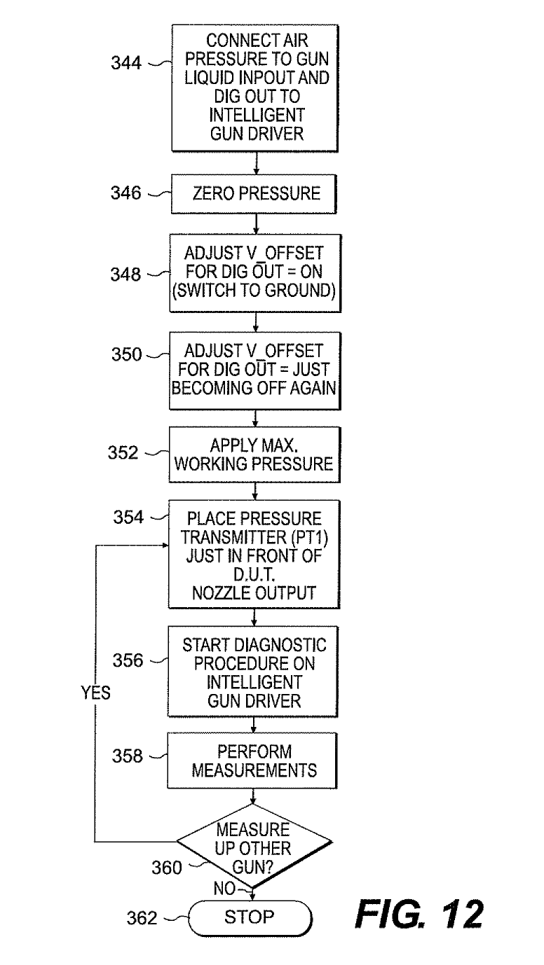

The flow chart of FIG. 12 illustrates one exemplary method for calculating gun parameters using the example circuit for detecting the on/off position of an electric spray gun illustrated in FIG. 11. At stage 344, the liquid feed port 112 is connected to a device providing air pressure, such as an air compressor. The circuit illustrated in FIG. 11 is connected to the gun 100 and the digital output 378 provides data to the example gun diagnostics procedure illustrated in FIG. 10. At stage 346, no air pressure is applied to the system. At stage 348, the offset voltage 376 is adjusted such that the output 378 of FET switch 380 is on at barometric pressure. At stage 350 the reference voltage 376 is adjusted such that the output 378 just goes to off at barometric pressure.

The maximum working pressure is applied to the gun at stage 352 and the pressure transmitter is placed in front of the gun nozzle 148 at stage 354. The maximum working pressure is applied because the solenoid's magnetic force must overcome both the mechanical forces from the spring 146 and friction as well as the forces from the sprayed liquid. At stage 356 the diagnostic procedure is performed. FIG. 10 provides one example of a diagnostic procedure for use with the method illustrated in FIG. 12. At stage 358 the measurements are taken in accordance with the diagnostic procedure of stage 356. At stage 360 it is determined if another gun is to be measured. If another gun is to be measured the method returns to stage 354 using the new gun. If no additional guns are to be measured, the method ends at stage 362.

The method provided in FIG. 12 provides one way to use an on/off detection circuit to generate gun parameters. An on/off detection circuit can also be integrated into an electric spray gun such that the on/off status of the gun is used directly in the gun's control procedure. For example, FIG. 9 provides an exemplary method for controlling a spray gun that directly utilizes the on/off status of the gun.

Electric spray guns and spray gun systems as described herein provide a number of benefits and improvements. Some embodiments of the invention provide a spray gun system that is easily and efficiently installed. Additional embodiments of the invention provide a spray gun system that is power efficient. More rapid gun opening and gun closing times can be achieved through the use of the invention. For example the flow chart of FIG. 8 illustrates an exemplary method of driving an electric spray gun to achieve fast opening and fast closing times. Aspects of the exemplary systems and methods can be combined to achieve power efficiency, ease of system configuration and fast opening and closing times for spray gun systems.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An electric spray gun system comprising:
a gun driver connected to an electric spray gun having a solenoid with a longitudinal axis, the gun driver supplying a low frequency pulse width modulated power signal to the spray gun solenoid;
a plunger disposed at least partially within the solenoid, the plunger being mounted for substantially linear movement relative to the solenoid longitudinal axis in response to the solenoid being energized by the power signal from the gun driver; and
a control circuit for controlling the gun driver,
the control circuit being adapted to vary the duty cycle of the modulated power signal generated by the full bridge gun driver in order to vary the amount of a material being sprayed by the spray gun.

2. The electric spray gun system of claim 1 wherein the control circuit is further adapted to hold the power signal high from a first time when the plunger is in a closed position until a second time when the plunger is in an open position.

3. The electric spray gun system of claim 2 wherein after the second time, the power signal is modulated at a high frequency until a third time.

4. The electric spray gun system of claim 3 wherein after the third time, the power signal is held in a negative state until a fourth time when the current through the solenoid is substantially zero.

5. The electric spray gun system of claim 1 wherein the gun driver is a full bridge driver circuit.

6. The electric spray gun system of claim 1 wherein the control circuit monitors a source current and sink current from a power supply connected to the gun driver and issues an alarm if the source current and sink current fall outside of a specified range.

7. The electric spray gun system of claim 1 wherein the control circuit is further adapted to monitor a voltage supplied from a power supply to the gun driver.

8. The electric spray gun system of claim 1 wherein the control circuit is further adapted to monitor whether the plunger is in an open position or a closed position.

9. A method of driving a spray gun having a known nominal working voltage, holding current, minimum opening time and minimum closing time, the method comprising:
applying a positive nominal working voltage from a full bridge driver circuit to a solenoid within the spray gun for a time period equal to the minimum opening time for the spray gun;
removing the bridge driver circuit voltage from the solenoid until the solenoid current is approximately equal to the holding current for the spray gun;
maintaining an approximately constant current through the solenoid by applying a high frequency modulated power signal;
applying a negative nominal working voltage from the full bridge driver circuit to the solenoid for a period of time equal to the minimum closing time for the spray gun.

10. The method of claim 9 wherein the solenoid current is taken in series with the solenoid.

11. The method of claim 9 wherein a full bridge driver source current and a full bridge driver sink current are monitored.

12. The method of claim 9, further comprising calculating the holding current, minimum opening time and minimum closing time at a time that the spraying system is initiated.

13. A method of driving a spray gun having a known nominal working voltage, holding current and on current comprising in order:
applying a positive voltage with an amplitude greater than the nominal working voltage from a full bridge driver circuit to a solenoid within the spray gun until the current through the solenoid equals the on current for the gun;
removing the bridge driver circuit voltage from the solenoid until the solenoid current is approximately equal to the holding current for the spray gun;
maintaining an approximately constant current through the solenoid by applying a high frequency modulated power signal;
applying a negative voltage with an amplitude greater than the nominal working voltage from the full bridge driver circuit to the solenoid until the current through the solenoid is substantially zero.

14. The method of claim 13 wherein the solenoid current is taken in series with the solenoid.

15. The method of claim 13 wherein a full bridge driver source current and a full bridge driver sink current are monitored.

16. The method of claim 13 further comprising calculating the holding current and on current at the time the spraying system is initiated.

17. A method of driving a spray gun having a known nominal working voltage, holding current and on current comprising in order:
applying a positive voltage with an amplitude greater than the nominal working voltage from a full bridge driver circuit to a solenoid within the spray gun until the current through the solenoid equals the on current for the gun;
removing the bridge driver circuit voltage from the solenoid until the solenoid current is approximately equal to the holding current for the spray gun;
maintaining an approximately constant current through the solenoid by applying a high frequency modulated power signal;
applying a negative voltage with an amplitude greater than the nominal working voltage from the full bridge driver circuit to the solenoid and monitoring the current through the solenoid;
removing the negative voltage from the full bridge driver when the current flow through the solenoid transitions from a negative value to a positive value.

18. The method of claim 17 further comprising measuring the current through the solenoid by monitoring the current flow on the source side of the full bridge driver.

19. The method of claim 17 further comprising measuring the current through the solenoid by monitoring the current flow on the sink side of the full bridge driver.

20. The method of claim 17 further comprising approximating the current through the solenoid by intermittently measuring the time needed for the current to transition from a negative value to a positive value and using the measured time as the approximation.

21. The method of claim 17 wherein a microprocessor controls the full bridge driver.

22. The method of claim 17 further comprising monitoring the full bridge driver source current and the full bridge driver sink current.

23. A method of driving a spray gun having a known nominal working voltage and holding current comprising in order:
applying a positive voltage with an amplitude greater than the nominal working voltage from a full bridge driver circuit to a solenoid within the spray gun until the gun opens;
removing the bridge driver circuit voltage from the solenoid until the solenoid current is approximately equal to the holding current for the spray gun;
maintaining an approximately constant current through the solenoid by applying a high frequency modulated power signal;
applying a negative voltage with an amplitude greater than the nominal working voltage from the full bridge driver circuit to the solenoid until the gun closes.

24. The method of claim 23 further comprising determining whether the gun is open using a pressure sensitive transmitter circuit.

25. The method of claim 23 further comprising determining whether the gun is closed using a pressure sensitive transmitter circuit.

26. The method of claim 23 further comprising determining the solenoid current by one of (1) measuring the current flow on the sink side of the full bridge driver or (2) measuring the current flow on the source side of the full bridge driver.

27. The method of claim 23 further comprising controlling the full bridge driver with a microprocessor.

28. A method of determining the characteristics of a spray gun having a solenoid and a known nominal working voltage, the method comprising in order:
applying the nominal working voltage for the spray gun;
detecting the opening of the gun and measuring the current through the solenoid;
continuing to apply the nominal working voltage until the current through the solenoid reaches a substantially steady state.
measuring the steady state current through the solenoid;
modulating the power signal such that the duty cycle of the high frequency modulated signal decreases over time until detection of the closing of the gun;

29. The method of claim 28 wherein after the step of detecting the opening of the gun, measuring the gun's on current.

30. The method of claim 28 wherein after the modulating the power signal such that the duty cycle of the high frequency modulated signal decreases over time until detection of the closing of the gun step, measuring the off current of the gun.

31. The method of claim 28 wherein the method is performed when a spraying system is initialized.

32. A method of detecting the on off status of a spray gun having a nozzle comprising:
adjusting a pressure sensitive transmitter circuit such that the circuit is in one state at or below barometric pressure and in a second state at pressures above barometric pressure;
placing the pressure sensitive transmitter circuit in front of the nozzle of the spray gun such that the pressure sensitive transmitter circuit detects changes in pressure at the nozzle of the spray gun;
applying pressure through the spray gun and detecting the change in pressure through use of the pressure sensitive transmitter circuit.
